(19) United States
(12) Patent Application Publication
(10) Pub. No.: US 2007/0070081 A1
(43) Pub. Date: Mar. 29, 2007

(54) On screen display control device and related control method thereof

(75) Inventors: Sen-Huang Tang, Lo Tung Town (TW); Hsu-Jung Tung, Kao Hsiung City (TW); Chia-Wei Yu, Taipei City (TW)

Correspondence Address: BIRCH STEWART KOLASCH & BIRCH, PO BOX 747, FALLS CHURCH, VA, 22040-0747, US

(73) Assignee: Realtek Semiconductor Corp.

(21) Appl. No.: 11/522,987

(22) Filed: Sep. 19, 2006

(30) Foreign Application Priority Data
Sep. 26, 2005 (TW) 094133294

(51) Int. Cl. G09G 5/02

(52) U.S. Cl. 345/591

(57) ABSTRACT

An on screen display control device includes a plurality of setting tables, a setting unit, an analysis unit, a parameter generating unit and an adjusting unit. The on screen display control device adjusts a plurality of display parameters of an original image data at a time.

### BACKGROUND OF THE INVENTION

1. Field of the Invention

The present invention relates to an on screen display control device, and more particularly, to an on screen display control device capable of simultaneously adjusting a plurality of display parameters of an original image data and related control method thereof.

2. Description of the Prior Art

FIG. 1 shows a schematic diagram illustrating a conventional display device 10. The display device 10, such as a digital TV, a computer monitor, etc., comprises an on screen display (OSD) control device 11. The OSD control device 11 is utilized to adjust the displaying settings of the display device 10. For example, the OSD control device 11 can adjust the contrast, brightness, sharpness, operation frequency, etc. of the display device 10. For a user, if the user adjusts the picture of the display device 10 through the OSD control device 11, the user needs to one by one adjust the above-mentioned displaying settings. For example, the user can first adjust the brightness, and then adjust the contrast after the brightness is completely adjusted. Further, other adjusting options are then selected by the user to perform the adjusting operation until the user is satisfied with all color parameters.

Maybe the display device 10 can be optimized through the above-mentioned procedure. But for the user, this is inconvenient and consumes a huge amount of time. Furthermore, it is possible that the user cannot adjust the display device 10 to make the display device 10 having a better displaying effect. Inversely, the display device 10 may show an image having a worse displaying effect after adjustment. This really annoys the users.

Therefore, it is important to provide an OSD control device and OSD control method for the user to easily adjust the displaying effects of the display device.

### SUMMARY OF THE INVENTION

Hence, an object of the invention is to provide an OSD control device and control method. The user can select any of predetermined options, or input at least one parameter of predetermined parameters to adjust the displaying effects of the display device such that the above-mentioned problem can be solved.

According to an exemplary embodiment of the claimed invention, an on screen display control device is disclosed. The OSD control device comprises: a plurality of setting tables, each comprising a plurality of parameters; a setting unit, for receiving a selecting signal to select one of the plurality of setting tables and generating a setting signal according to the parameters of the selected setting table; an analysis unit, for receiving an original image data and generating an original parameter signal according to color parameters of the original image data; a parameter generating unit, for generating a target parameter signal according to the setting signal and the original parameter signal; and an adjusting unit, for adjusting the color parameters of the original image data according to the target parameter signal to generate a target image data.

According to another exemplary embodiment of the claimed invention, an on screen display control method is disclosed. An on screen display control method comprises the step of providing a plurality of setting tables, each comprising a plurality of parameters; selecting one of the setting tables and generating a setting signal according to the parameters of the selected setting table; receiving an original image data; analyzing color parameters of the original image data to generate an original parameter signal; generating a target parameter signal according to the setting signal and the parameter signal; and adjusting the color parameters of the original image data according to the target parameter signal to generate a target image data.

Please note, the parameters of each setting table are corresponding to the region, language, Greenwich mean time, culture, nation, and country. Each setting table comprises at least one parameter different from the parameter of the other setting tables. And the color parameters of the original image data comprise the contrast, luminance, chrominance, saturation, brightness, color temperature, and white balance.

The present invention OSD control device and OSD control method store all factors, which influence the vision effects of the user, as the parameters in the setting tables. Furthermore, the present invention provides a plurality of options of the setting tables for the user to choose, or the present invention can allow the user to input values of some parameters. Therefore, the inputted value of parameters can be utilized to automatically set the displaying effects of the display device. In this way, the user only has to simply select one of the options or input some values of parameters. A plurality of color parameters (contrast, brightness, saturation, chrominance, color temperature, and white balance) can be set in a time through the setting table so that the displaying effect of the display device can meet the demand of the user. In contrast to the prior art, the prior art needs to set each color parameter individually. Therefore, the present invention OSD control device and related OSD control method can allow the user to determine the settings more easily and to quickly adjust the displaying effect to meet the demand of the user.

### BRIEF DESCRIPTION OF THE DRAWINGS

FIG. 1 is a diagram of a conventional display device.

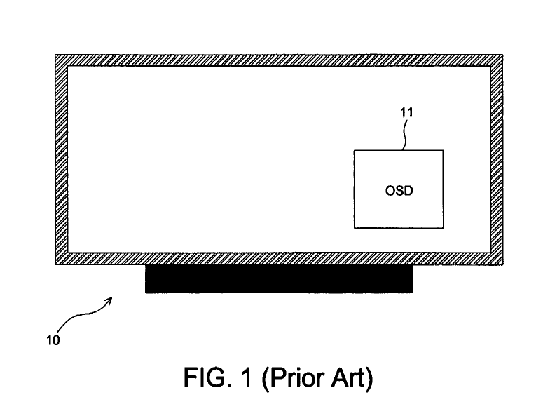

FIG. 2 is a diagram of an OSD control device according to the present invention.

FIG. 3 is a flow chart of an OSD control method according to the present invention.

FIG. 4 is a diagram of a color form according to the present invention.

FIG. 5 is a diagram of a classifying form according to the present invention.

### DETAILED DESCRIPTION OF THE PREFERRED EMBODIMENT

In general, people in different nations, areas, GMTs (Greenwich mean time), countries, having different culture, or using different languages often have different favors in colors. For example, Spanish often likes warm colors (such as red, orange, yellow, and umber). These warm colors give people a warm feeling and enthusiasm. On the other hand, Japanese prefers cold colors (such as cyan, green, and purple). These cold colors give people a quiet, elegant, pure feeling. Obviously, Spanish and Japanese have different tastes in colors.

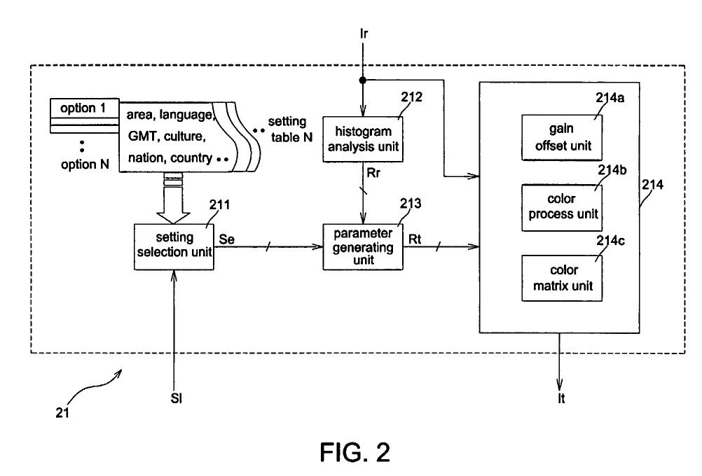

Please refer to FIG. 2, which is a diagram of an OSD control device 21 according to the present invention. The OSD control device 21 comprises a plurality of setting tables, a setting selection unit 211, a histogram analysis unit 212, a parameter generating unit 213, and an adjusting unit 214. The OSD control device 21 stores the factors, which influence the visual effects, as parameters in the setting tables, and provides a plurality of options corresponding to the setting tables to the user. Or the OSD control device 21 asks the user to input the values of some parameters. Therefore, a setting table can be indicated through selecting one of these options or inputting the values of the parameters. Thus different parameters of different setting tables can be utilized to automatically adjust the displaying effects of the present invention display device (not shown).

The setting tables 1˜N respectively have different displaying styles. The options 1˜N are utilized as indexes, for selecting corresponding setting tables 1˜N. Therefore, the options 1˜N can correspond to a plurality of pictures having different displaying effects. Please note, the displaying effect of each picture represents at least one of the contrast, brightness, chrominance, saturation, luminance, color temperature, and white balance. Surely, the picture can correspond to a same image having different displaying effects. In addition, each setting table 1˜N comprises at least one of area, language, GMT, culture, nation, and country. And each setting table 1˜N comprises at least one parameter different from that of the other setting tables. For example, the parameter “country” of the setting table 1 is China. The parameter “country” of the setting table 2 is Spain.

After the user input at least one parameter value of at least one parameter or select any of the options of the setting tables 1˜N through an input interface (not shown), the input interface generates a selecting signal S1. The setting selection unit 211 receives the selecting signal S1 and selects a setting table according to the selecting signal S1 so that a corresponding setting signal Se is generated. The histogram analysis unit 212 receives an original image data Ir, analyzes color parameters of the original image data Ir to generate an original parameter signal Rr. Please note that the color parameters include at least one of contrast, brightness, chrominance, saturation, luminance, color temperature, and white balance. The parameter generating unit 213 receives the setting signal Se and the original parameter signal Rr, and generates a target parameter signal Rt according to the setting signal Se and the original parameter signal Rr. The adjusting unit 214 receives the original image data Ir, and adjusts the color parameters of the original image data Ir according to the target parameter signal Rt to generate a target image data It. In this embodiment, the adjusting unit 214 includes a gain offset unit 214a, a color process unit 214b, and a color matrix unit 244c. In other embodiments, the adjusting unit 214 includes at least one of the above-mentioned 214a, 214b, and 214c, or other units capable of processing displaying effects. The gain offset unit 214a adjusts at least one of the contrast and brightness of the original image data Ir according to the target parameter signal Rt. The color process unit 214b adjusts at least one of the chrominance, saturation, and luminance of the original image data Ir according to the target parameter signal Rt. The color matrix unit 214c adjusts at least one of the color temperature and white balance of the original image data Ir according to the target parameter signal Rt. After the adjustment performed by the gain offset unit 214a, the color process unit 214b, and the color matrix process unit 214c, the above-mentioned target image data It is generated and displayed for the user.

In the following disclosure, the operation of the present invention OSD control device 21 will be illustrated. Assume that the option 1 is the Chinese style, the option 2 is the Spanish style, and the option 3 is France style. Firstly, after the user selects the option 1 (Chinese style) through the input interface, the input interface generates a selecting signal S1. The setting selection unit 211 receives the selecting signal S1 and selects the setting table 1 corresponding to the option 1. The values of the parameters of the setting table 1 are: “region”—Asia, “language”—simplified Chinese, “GMT”—GMT+08:00, “culture”—the culture of tang dynasty, “nation”—Chinese, “country”—China. Therefore, the setting selection unit 211 generates a setting signal Se according to the values of the parameters. The histogram analysis unit 212 receives an original image data Ir, analyzes the color parameters of the original image data Ir, and generates an original parameter signal Rr. And then, the parameter generating unit 213 receives the setting signal Se and the original parameter signal Rr, and generates a target parameter signal Rt according to the setting signal Se and the original parameter signal Rr. The adjusting unit 214 receives the original image data Ir, and adjusts the color parameters (e.g.: contrast, brightness, chrominance, saturation, luminance, color temperature, and white balance) according to the target parameter signal Rt so that the adjusting unit 214 generates a Chinese-style target image data It, which is mainly based on the yellow color. Furthermore, the target image data It is outputted for the user to watch. Therefore, the OSD control device 21 finally adjusts the displaying color of the display device 10 to a Chinese-style, which is based on the yellow color. Surely, the option 1 (Chinese style) can further comprise more detailed sub-options, or sub-options arranged in a tree-shape. For example, the option 1-0 can be “Chinese-style, Beijing”, the option 1-1 can be “Chinese-style, shanghai”, . . . etc. Similarly, these sub-options correspond to a plurality of sub-setting tables, where each sub-setting table comprises at least one value of parameter different from that of the other sub-setting tables. On the other hand, if the user selects the option 2 (Spanish-style), the values of the parameters of the corresponding setting table 2 are: “region”—west Europe, “language”—Spanish, “GMT”—GMT+01:00, “culture”—Spanish culture, “nation”—Spanish, “country”—Spain. Therefore, the OSD control device 21 adjusts the color of the display device to a Spanish-style, which is based on red color.

On the other hand, the user can input the value of at least one parameter of the setting table through the input interface so that the color displayed by the display device 10 can be adjusted. For example, the user can input the values of the parameters: “country”—Japan, “region”—Asia. And then, the setting selection unit 211 can select the setting tables comprising the parameter values of Japan and Asia according to the selection signal S1 generated by the input interface, and generates a setting signal Se for the following process. Therefore, the OSD control device 21 can adjust the displaying color of the display device 10 into the Japanese-style color, which is based on some cold colors.

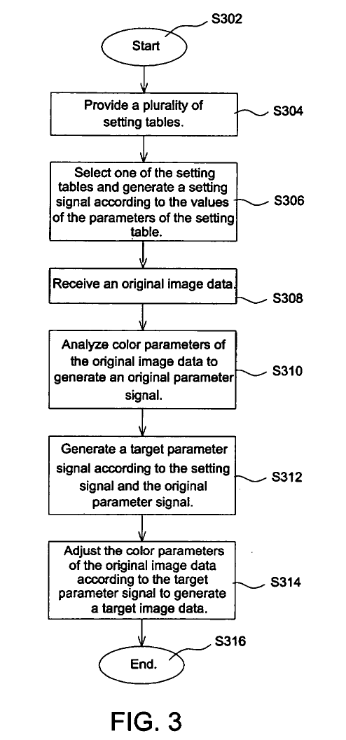

Please refer to FIG. 3, which is a flow chart of an OSD control method according to the present invention. The control method includes the following steps:

Step S302: Start.

Step S304: Provide a plurality of setting tables. Wherein, the setting table comprises at least one of a plurality of parameters (including region, language, GMT, culture, nation, country, etc.). Furthermore, each setting table comprises different value of the parameter which is different from that of the other setting tables. For example, the first setting table may comprise a parameter value “country”—China, but the second setting table may comprise all the same parameter values expect for a different parameter value “country”—Spain.

Step S306: Select one of the setting tables and generate a setting signal according to the values of the parameters of the setting table.

Step S308: Receive an original image data.

Step S310: Analyze color parameters of the original image data to generate an original parameter signal. Wherein, the color parameters of the original parameter data comprise at least one of contrast, brightness, chrominance, saturation, luminance, color temperature, and white balance.

Step S312: Generate a target parameter signal according to the setting signal and the original parameter signal.

Step S314: Adjust the color parameters of the original image data according to the target parameter signal to generate a target image data.

Step S316: End.

Please note, in step S306, the operation of selecting one of the setting tables 1˜N can be performed through utilizing predetermined options 1˜N or through inputting a value of a specific parameter to select the setting table having the inputted parameter value.

The present invention OSD control device and OSD control method can store the factors which influence the vision effects of the user, as the parameters in the setting tables 1˜N. Furthermore, the present invention provides a plurality of options 1˜N for the user to choose. Or, the present invention can allow the user to input values of some parameters to select the setting table corresponding to the input parameter values. Therefore, the inputted value of parameters can be utilized to automatically set the displaying effects of the display device. In this way, as long as the user only have to simply select one of the options 1˜N or input some values of parameters, a plurality of color parameters (contrast, brightness, saturation, chrominance, color temperature, and white balance) can be set in a time through the setting table so that the displaying effect of the display device can meet the demand of the user.

In addition, the present invention can utilize other methods to help the user to adjust the displaying effects of the display device. For example, the present invention can utilize a questionnaire method to communicate with the user in order to allow the user to input data. And then, the present invention can analyze the inputted data to determine the color favors of the user, and adjust the color parameters of the original image data Ir by utilizing the setting signal Se generated according to the setting tables complying with the color favors.

Or, the present invention can provide a mixing color plate, the setting tables corresponding to the colors in the mixing color plate. This allows the user to select the favorite colors. Therefore, the present invention can utilize the favorite colors to utilize corresponding setting tables to generate the setting signal Se so that the color parameters of the original image data Ir can be adjusted.

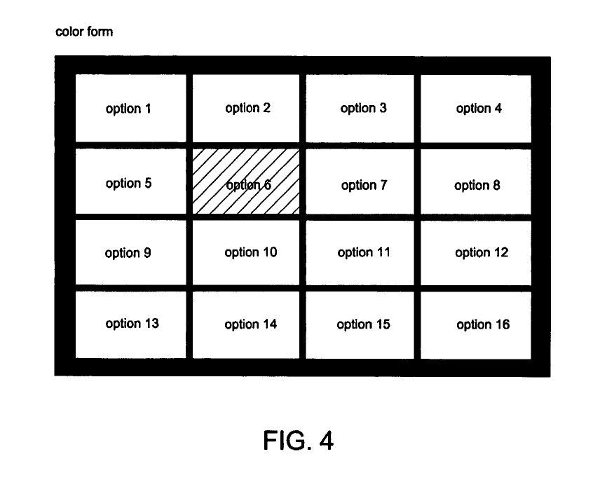

Or, the present invention can provide a color form comprising a plurality of color options and the setting tables corresponding to the color options. Similarly, the user can select the favorite colors. And the present invention can similarly generate the setting signal Se according to the favorite colors selected by the user to further adjust the color parameters of the original image data Ir. The color form is shown in FIG. 4. In FIG. 4, the color form comprises 16 color options for the user to select. For example, the user can select the option 6 to adjust the display of the display device into a pink-style (here, we assume the color option 6 corresponds to the color “pink”). Surely, the number of the color options is not limited, and each color option can comprise a plurality of sub-options, whose color is close to the color of the color option. For example, assume that the color option 1 corresponds to the color “blue”. Then, the sub-options of the color option 1 can correspond to the colors “water blue, “indigo”, “dark blue,” etc.

In addition, please refer to FIG. 2 again. In another embodiment of the present invention, the OSD control device 21 and the control method can show a plurality of pictures, which correspond to the same image but have different display effects, on the screen (not shown). Furthermore, each picture shown on the screen corresponds to a setting table. Therefore, as long as the user selects one of the display screens, a control signal S1 can be generated. And the setting selection unit 211 can utilize the control signal S1 to use the corresponding setting table so that a setting signal Se can be generated. Therefore, the OSD control device 21 can output the target image data It according to the setting signal Se through the above-mentioned operations. Please note, the difference between the display effects of the pictures shown on the screen corresponds to at least one of the color parameters, such as contrast, brightness, saturation, luminance, color temperature, and white balances. Furthermore, the above-mentioned pictures can correspond to different image data and the pictures can also correspond to a same image having different displaying effects. This change also obeys the spirit of the present invention.

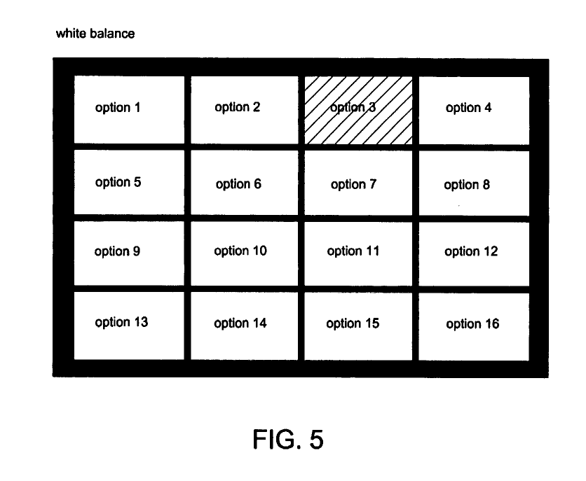

In addition, the present invention OSD control device and control method can provide a classifying form, for focusing on adjusting one of the color parameters (contrast, brightness, chrominance, saturation, luminance, color temperature, and white balance) of the original image data Ir. As shown in FIG. 5, the classifying form includes 16 different options of white balance. Therefore, the user can select one of the options to adjust the white balance between the light source of the display device 10 and the ambient lights. From FIG. 5, it is easily seen that the user selects the option 3. Similarly, the number of the options of the white balance is not limited. And each option can comprise a plurality of sub-options, which corresponds to the white balance close to the white balance of the main option. This change also obeys the spirit of the present invention.

In contrast to the prior art, the prior art needs to set each color parameter individually. Therefore, the present invention OSD control device and related OSD control method can allow the user to determine the settings more easily and to quickly adjust the displaying effect to meet the demand of the user.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An on screen display control device, comprising:
a plurality of setting tables, each comprising at least one parameter;
a setting unit for receiving a selecting signal to select one of the plurality of setting tables and generating a setting signal according to the parameter of the selected setting table;
an analysis unit for receiving an original image data and generating an original parameter signal according to color parameters of the original image data;
a parameter generating unit for generating a target parameter signal according to the setting signal and the original parameter signal; and
an adjusting unit for adjusting the color parameters of the original image data according to the target parameter signal to generate a target image data.

2. The on screen display control device of claim 1, wherein the adjusting unit comprises at least one of the following units:
a gain offset unit for adjusting at least one of a contrast parameter and a luminance parameter of the original image data according to the target parameter signal;
a color process unit for adjusting at least one of a chrominance, a saturation, and a brightness of the original image data according to the target parameter signal; and
a color matrix unit for adjusting at least one of a color temperature and a white balance of the original image data according to the target parameter signal.

3. The on screen display control device of claim 1, wherein the parameter of each setting table is corresponding to the region, language, Greenwich mean time, culture, nation, or country.

4. The on screen display control device of claim 1, wherein each setting table comprises at least one parameter different from the parameter of the other setting tables.

5. The on screen display control device of claim 4, wherein the setting tables correspond to a plurality of options, and one of the options is selected by a user to generate the selecting signal.

6. The on screen display control device of claim 5, wherein the options correspond to pictures having different displaying effects.

7. The on screen display control device of claim 6, wherein the displaying effect of each picture corresponds at least one of the contrast, luminance, chrominance, saturation, brightness, color temperature, and white balance.

8. The on screen display control device of claim 6, wherein the pictures correspond to a same image having different displaying effects.

9. The on screen display control device of claim 4, wherein at least one parameter of the setting tables is inputted through an input interface to generate the selecting signal.

10. The on screen display control device of claim 1, wherein the color parameters of the original image data comprise at least two of the contrast, luminance, chrominance, saturation, brightness, color temperature, and white balance.

11. An on screen display control device, comprising:
a plurality of setting tables, each comprising at least one parameter;
a setting unit for receiving a selecting signal to select one of the setting tables and generating a setting signal according to the parameter of the selected setting table;
a parameter generating unit for receiving the setting signal and an original image data and generating a target parameter signal according to the setting signal and the original image data; and
an adjusting unit for generating a target image data according to the original image data and the target parameter signal.

12. The on screen display control device of claim 11, further comprising:
an analysis unit for analyzing color parameters of the original image data and inputting the color parameters of the original image data to the parameter generating unit.

13. The on screen display control device of claim 11, wherein the adjusting unit comprises at least one of the following units:
a gain offset unit for adjusting at least one of a contrast parameter and a luminance parameter of the original image data according to the target parameter signal;
a color process unit for adjusting at least one of a chrominance, a saturation, and a brightness of the original image data according to the target parameter signal; and
a color matrix unit for adjusting at least one of a color temperature and a white balance of the original image data according to the target parameter signal.

14. The on screen display control device of claim 11, wherein the parameter of each setting table is corresponding to the region, language, Greenwich mean time, culture, nation, or country.

15. The on screen display control device of claim 11, wherein each setting table comprises at least one parameter different from the parameter of the other setting tables.

16. The on screen display control device of claim 15, wherein the setting tables correspond to a plurality of options, and one of the options is selected by a user to generate the selecting signal.

17. The on screen display control device of claim 16, wherein the options correspond to pictures having different displaying effects.

18. The on screen display control device of claim 17, wherein the displaying effect of each picture corresponds at least one of the contrast, luminance, chrominance, saturation, brightness, color temperature, and white balance.

19. The on screen display control device of claim 17, wherein the pictures correspond to a same image having different displaying effects.

20. The on screen display control device of claim 15, wherein at least one parameter of the setting tables is inputted through an input interface to generate the selecting signal.

21. The on screen display control device of claim 11, wherein color parameters of the original image data comprise at least two of the contrast, luminance, chrominance, saturation, brightness, color temperature, and white balance.

22. An on screen display control method comprising:
providing a plurality of setting tables, each comprising at least one parameter;
selecting one of the setting tables and generating a setting signal according to the parameter of the selected setting table;
receiving an original image data;
analyzing color parameters of the original image data to generate an original parameter signal;
generating a target parameter signal according to the setting signal and the original parameter signal; and
adjusting the color parameters of the original image data according to the target parameter signal to generate a target image data.

23. The on screen display control method of claim 22, wherein the parameter of each setting table is corresponding to the region, language, Greenwich mean time, culture, nation, or country.

24. The on screen display control method of claim 22, wherein each setting table comprises at least one parameter different from the parameter of the other setting tables.

25. The on screen display control method of claim 22, wherein the color parameters of the original image data comprise at least two of the contrast, luminance, chrominance, saturation, brightness, color temperature, and white balance.

26. An on screen display control method comprising:
providing a plurality of setting tables, each comprising at least one parameter;
receiving an original image data;
selecting one of the setting tables; and
adjusting color parameters of the original image data according to the parameter of the selected setting table to generate a target image data.

27. The on screen display control method of claim 26, wherein the parameter of each setting table is corresponding to the region, language, Greenwich mean time, culture, nation, or country.

28. The on screen display control method of claim 26, wherein each setting table comprises at least one parameter different from the parameter of the other setting tables.

29. The on screen display control method of claim 26, wherein the color parameters of the original image data comprise at least two of the contrast, luminance, chrominance, saturation, brightness, color temperature, and white balance.
